(19) United States
(12) Patent Application Publication
(10) Pub. No.: US 2009/0116847 A1
(43) Pub. Date: May 7, 2009

(54) OPTICAL TRANSCEIVER WITH IN-BAND MANAGEMENT CHANNEL

(76) Inventors: Xiaodong DUAN, Fremont, CA (US); Samuel Liu, San Jose, CA (US); Giovanni Barbarossa, Saratoga, CA (US)

Correspondence Address: PATTERSON & SHERIDAN, LLP, 3040 POST OAK BLVD, SUITE 1500, HOUSTON, TX, 77056, US

(21) Appl. No.: 11/935,324

(22) Filed: Nov. 5, 2007

(51) Int. Cl. H04B 10/00

(52) U.S. Cl. 398/137

(57) ABSTRACT

A supervisory signal is superimposed onto a high-speed data stream so that the number of optical transceivers needed by an optical network is reduced. The supervisory signal is superimposed onto the high-speed data stream as an in-band modulation of the data stream. To improve signal-to-noise ratio of the in-band supervisory signal, the supervisory signal is first modulated to a higher frequency before it is superimposed onto the high-speed data stream.

### BACKGROUND OF THE INVENTION

1. Field of the Invention

Embodiments of the present invention relate generally to optical communication systems and, more particularly, to an optical transceiver used in such systems.

2. Description of the Related Art

Optical networks are used extensively in telecommunications for voice and other applications. As utilization of optical communication networks increases, there is an ongoing effort to lower the per-bit cost of data transport. Some components of optical communication networks become increasingly expensive when designed for higher speed optical networks, such as 1 Gigabit Ethernet (1 GbE), 2.5 Gigabit SONET networks, and faster networks. For this reason, the added cost of high-speed components can partially negate the per-bit cost savings associated with upgrading an optical communications network to a higher bit rate.

One relatively expensive component of an optical communications network is the optical transceiver, for example the small form-factor pluggable (SFP) transceiver. Optical transceivers are located at each node of an optical network, and interface a network switch, router, or similar device with a fiber optic networking cable. Optical transceivers are required for data signals and a separate optical transceiver is required for a supervisory signal.

Each supervisory signal, also referred to as an optical supervisory channel (OSC), is propagated together with data signals along an optical link established between nodes of the network, and contains information for maintaining and monitoring the optical link, including input power, output power, node temperature, etc. In addition, the OSC may be used for remote upgrades of the software controlling network devices contained in network nodes. Because the OSC transceiver at each network node does not increase the data transport capacity of the network, each OSC transceiver negatively impacts the per-bit cost of data transport for the network. This is especially true for networks designed to multiplex a relatively small number of data signals onto a single optical fiber, such as coarse wavelength-division multiplexing (CWDM) systems.

Accordingly, there is a need in the art for a low-cost data transport solution for high-speed optical networks that does not require an OSC transceiver at each node of the network.

### SUMMARY OF THE INVENTION

Embodiments of the present invention provide a method and apparatus for high-speed, low-cost transport of data signals that eliminate the need for dedicated OSC transceivers in an optical network.

In one embodiment of the invention, an optical transceiver for a communications network comprises an optical-to-electrical assembly configured to receive a first optical signal containing a first data signal and a first supervisory signal and separate the first optical signal into the first data signal and the first supervisory signal, and an electrical-to-optical assembly configured to receive a second data signal and a second supervisory signal, and generate a second optical signal containing the second data signal and the second supervisory signal.

A method of transmitting a supervisory signal between a first and second node of an optical communication network, according to an embodiment of the invention, comprises the steps of receiving a supervisory signal, combining the supervisory signal with a data signal having a frequency of at least 1 GHz, converting the combined signal to an optical signal, and transmitting the optical signal containing the supervisory signal from the first node to the second node.

A method of extracting a supervisory signal from a combined signal received from a node of an optical communication network, according to an embodiment of the invention, comprises the steps of receiving a combined signal having the supervisory signal and a data signal having a frequency of at least 1 GHz, extracting the data signal, and extracting the supervisory signal.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 compares the amplitude of 1/f noise in an optical link to the amplitudes of different data streams that may be transmitted through the optical link.

FIG. 2 schematically illustrates a supervisory signal, a modulated supervisory signal, a data signal, and a modulated data signal, that are generated according to an embodiment of the invention.

FIG. 3 schematically illustrates an optical transceiver configured to superimpose a modulated supervisory signal onto a high-speed data signal and separate a modulated supervisory signal from a high-speed data signal, according to an embodiment of the invention.

FIG. 4 is a flow chart summarizing an operating sequence for the optical transceiver depicted in FIG. 3, according to an embodiment of the invention.

FIG. 5 is a flow chart summarizing another operating sequence for the optical transceiver depicted in FIG. 3, according to an embodiment of the invention.

For clarity, identical reference numbers have been used, where applicable, to designate identical elements that are common between figures. It is contemplated that features of one embodiment may be incorporated in other embodiments without further recitation.

### DETAILED DESCRIPTION

Embodiments of the invention contemplate a method and apparatus for multiplexing, or combining, a supervisory signal with a high-speed data stream to eliminate the need for an OSC transceiver at each node of an optical network. The supervisory signal is incorporated into the high-speed data stream as an in-band modulation of the data stream. This is unlike a conventional supervisory signal, which is typically transmitted in a separate wavelength channel that has a wavelength outside the data band of the network. According to embodiments of the invention, the supervisory signal is superimposed as a modulation on the existing data stream, therefore a dedicated optical transceiver is not required to transmit or receive the OSC.

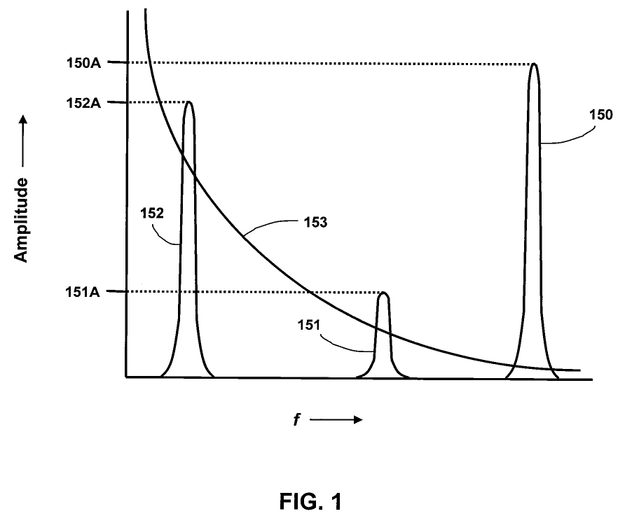

FIG. 1 compares the amplitude of 1/f noise in an optical link to the amplitudes of different data streams that may be transmitted through the optical link. Curve 153 represents the amplitude of 1/f noise, also referred to as “pink noise,” present in an optical link. As implied by its name, 1/f noise refers to a signal or process with a spectral power density inversely proportional to a frequency, f, associated with the signal or process. In the context of optical communication systems, f refers to the data frequency of optical signals transmitted via an optical link. Curve 150 represents a high-speed data signal having a data frequency of 1 GHz. Similarly, curve 151 represents an optical signal having a data frequency of 1 MHz and curve 152 represents an optical signal having a data frequency of approximately 10 kHz. As shown, a 1 MHz signal transmitted simultaneously through an optical link with a high-speed data signal may have a small amplitude relative to the 1 GHz signal and still be distinguishable from 1/f noise present in the optical link. To with, a 1 MHz signal, represented by curve 151, may have an amplitude 151A that is a small fraction of amplitude 150A of a high-speed data signal, represented by curve 150. Although amplitude 151A is a fraction of amplitude 150A, curve 151 has a favorable signal-to-noise ratio. In contrast, a 10 kHz signal, represented by curve 152, is obscured by 1/f noise, i.e., has a low signal-to-noise ratio, even when the 10 kHz signal has an amplitude 152A that is approximately equal to amplitude 150A of the high-speed data signal.

According to embodiments of the invention, a two-layer modulation of a low frequency supervisory signal onto a high-speed data signal in the GHz regime allows the incorporation of the low frequency supervisory signal into the high-speed data signal as an in-band subcarrier. As defined herein, a subcarrier is a separate, lower frequency signal modulated into a higher frequency primary signal. The supervisory signal may have a frequency as low as 1 kHz, and may first be modulated at an intermediate frequency before being incorporated into the high-speed data signal as a subcarrier. The use of an intermediate modulation frequency substantially improves the signal-to-noise ratio of the subcarrier.

In one embodiment, the supervisory signal is a 9.6 kHz signal that is modulated at an intermediate frequency of 1 MHz and then superimposed on a 1 GHz data signal, where the modulation depth of the 1 MHz signal is about 5%. Modulation depth, as defined herein, is the ratio of the amplitude of a subcarrier to the amplitude of the primary signal on which the subcarrier is superimposed. For reasons commonly known in the art, the modulation depth of a subcarrier is preferably less than about 10% in order to avoid adversely affecting the data contained in the primary signal. In this embodiment, the 1 GHz data signal serves as the primary signal and the supervisory signal modulated at 1 MHz serves as the subcarrier. In an alternative embodiment, the 9.6 kHz supervisory signal may be directly modulated onto the 1 GHz data signal, but this is less desirable because the signal-to-noise ratio for the supervisory signal will be much lower.

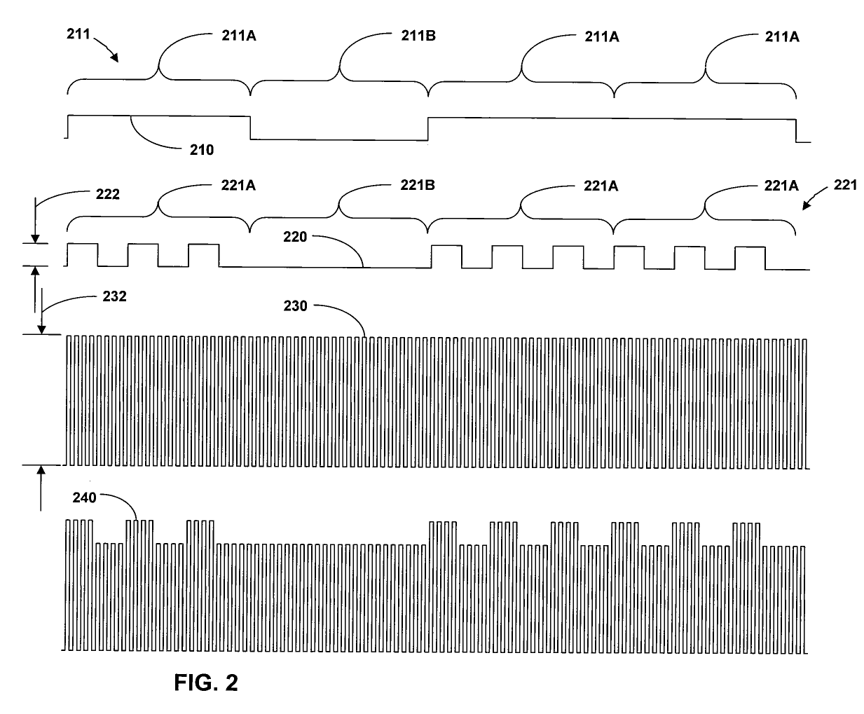

FIG. 2 schematically illustrates four signals that are generated in accordance with an embodiment of the invention. The four signals include a supervisory signal 210, a modulated supervisory signal 220, a data signal 230, and a modulated data signal 240. Because the frequencies of these signals may vary by several orders of magnitude, the relative wavelengths of these signals are not shown to scale for clarity. Supervisory signal 210, modulated supervisory signal 220, data signal 230, and modulated data signal 240 are depicted as square waves, although it is understood that each may be in a sinusoidal or other waveform.

Supervisory signal 210 is a low frequency signal, such as a 9.6 kHz RS232 signal, carrying the management data required to maintain an optical link established between two nodes of an optical network. Supervisory signal 210 contains a series of bits 211, where each bit is either a “1” or a “0.” In the example illustrated, bits 211A correspond to 1's and bit 211B corresponds to a 0.

Modulated supervisory signal 220 represents supervisory signal 210 after being modulated at a substantially higher frequency, in this embodiment on the order of 1 MHz. Modulated supervisory signal 220 contains a series of bits 221 that carries the identical low frequency signal as the series of bits 211 of supervisory signal 210. In modulated supervisory signal 220, however, each bit 221A and 221B is modulated at the 1 MHz frequency, as shown. This higher frequency modulation allows the information contained in supervisory signal 210 to be superimposed onto a high-speed data stream, i.e., a data stream having a frequency of 1 GHz or above, without being obscured by pink noise. In addition, because the magnitude of pink noise is substantially lower in the MHz regime than the kHz regime, the modulation depth of modulated supervisory signal 220 may be maintained relatively low. This minimizes interference between modulated supervisory signal 220 and modulated data signal 240, thereby preventing modulated supervisory signal 220 from adversely affecting the data contained in modulated data signal 240.

Data signal 230 represents a high-speed optical data stream carrying information to be transmitted between two nodes of an optical network. In the embodiment illustrated in FIG. 2, data signal 230 is a data stream having a frequency of 1 GHz or faster, such as a 1 Giga-bit Ethernet (1 GbE) signal or a 2.5 Giga-bit SONET signal. As shown, data signal 230 has an amplitude 232. Because amplitude 232 is approximately ten times greater than amplitude 222, the data traffic contained in data signal 230 will not be adversely affected when data signal 232 is combined with modulated supervisory signal 220 to form modulated data signal 240.

Modulated data signal 240 is a high-speed data signal corresponding to data signal 230 after the addition of modulated supervisory signal 220, which acts as a subcarrier having a frequency on the order of 1 MHz. Modulated supervisory signal 220 may be superimposed onto data signal 230 via an optical transceiver to form modulated data signal 240 prior to transmission of modulated data signal 240 from a network node. The modulation occurs when data signal 230 and modulated supervisory signal 220 are converted to a single optical signal, i.e., modulated data signal 240, by the optical transceiver. Thus, modulated data signal 240 includes the management information from supervisory signal 210 in addition to the information carried by data signal 230. Because the information from supervisory signal 210 is included in modulated data signal 240 as an in-band modulation, an additional transceiver for sending and receiving the supervisory information is not necessary.

In one embodiment, modulated supervisory signal 220 has an amplitude 222 that is between about 3% and 10% of amplitude 232 of data signal 230. Hence, the modulation depth of modulated supervisory signal 220 is also between about 3% and 10%. The optimal modulation depth of modulated supervisory signal 220 is a function of the transmission distance of modulated data signal 240, among other factors. This is because there is a performance trade-off between having a lower and a higher modulation depth for modulated supervisory signal 220. Lower modulation depth results in a lower signal-to-noise ratio for modulated supervisory signal 220, which is problematic for longer transmission distances. Higher modulation depth increases the signal-to-noise ratio for modulated supervisory signal 220, but may adversely affect the data contained in modulated data signal 240. Based on the foregoing, an optimal modulation depth for modulated supervisory signal 220 can be readily calculated.

Reconfigurable networks are currently under development, wherein the optical distance between two nodes of a network may change substantially depending on network utilization and other factors. For this reason, embodiments of the invention contemplate a modulated supervisory signal 220 having an adjustable modulation depth. In one embodiment, the modulation depth of modulated supervisory signal 220 may be varied between about 3% and about 10%, depending on changes in the transmission distance of modulated data signal 240 when the optical network is reconfigured.

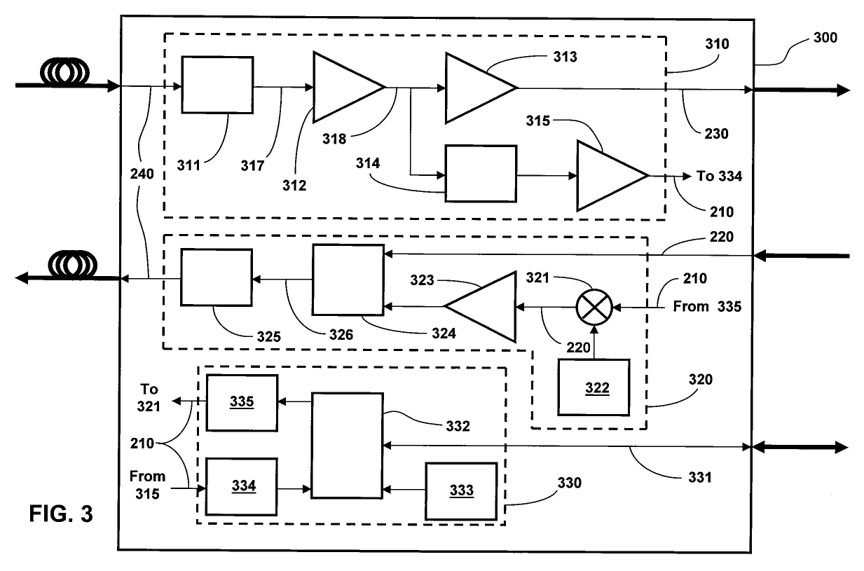

FIG. 3 schematically illustrates an optical transceiver 300 configured to superimpose a modulated supervisory signal onto a high-speed data signal and separate a modulated supervisory signal from a high-speed data signal, according to an embodiment of the invention. In this embodiment, optical transceiver 300 is an SFP transceiver located at a node in an optical communication network. Optical transceiver 300 includes an optical-to-electrical assembly 310, an electrical-to-optical assembly 320, and a supervisory channel module 330, and is configured to send, receive, or otherwise process supervisory signal 210, modulated supervisory signal 220, data signal 230, and modulated data signal 240, which are described above in conjunction with FIG. 2.

Optical-to-electrical assembly 310 is configured to receive modulated data signal 240 from an adjacent network node and convert modulated data signal 240 into two separate signals: supervisory signal 210 and data signal 230. Optical-to-electrical assembly 310 includes a receive optical subassembly (ROSA) 311, a trans-impedance amplifier 312, a limit amplifier 313, a bandpass filter 314, and an operational amplifier 315. ROSA 311 receives modulated data signal 240 from an adjacent network node, converts modulated data signal 240 into a modulated current signal 317, and transmits modulated current signal 317 to trans-impedance amplifier 312. Trans-impedance amplifier 312, which is a current-to-voltage converter, coverts modulated current signal 317 to modulated voltage signal 318. Modulated voltage signal 318 contains the same information as modulated data signal 240, i.e., a high-speed data signal with a two-layer modulation containing a lower frequency supervisory signal. As shown, a portion of modulated voltage signal 318 is directed to limit amplifier 313 and a portion is directed to bandpass filter 314 and operational amplifier 315. Limit amplifier 313 extracts data signal 230 from modulated voltage signal 318 for output to the network node containing optical transceiver 300. Together, bandpass filter 314 and operational amplifier 315 separate supervisory signal 210 from modulated voltage signal 318. Supervisory signal 210 is transmitted to supervisory channel module 330 via receiving universal asynchronous receiver/transmitter (UART) 334.

Electrical-to-optical assembly 320 is configured to receive data signal 230 and supervisory signal 210, modulate supervisory signal 210 onto data signal 230, and produce and transmit modulated data signal 240. Electrical-to-optical assembly 320 includes an input port 321, an oscillator 322, an operational amplifier 323, a laser driver 324, and a transmit optical subassembly (TOSA) 325. Input port 321 is configured to receive supervisory signal 210 from supervisory channel module 330 via transmitting UART 335. Oscillator 322 modulates supervisory signal 210 to produce modulated supervisory signal 220. Operational amplifier 323 couples input port 321 to laser driver 324 and adjusts the amplitude of modulated supervisory signal 220 higher or lower as required so that modulated supervisory signal 220 has a desired modulation depth when superimposed onto data signal 230. Laser driver 324 receives modulated supervisory signal 220 and data signal 230 from the network node containing optical transceiver 300, superimposes these signals to produce laser control signal 326, and transmits laser control signal 326 to TOSA 325. TOSA 325 converts laser control signal 326 into modulated data signal 240 and transmits modulated data signal 240 to an adjacent network node.

Supervisory channel module 330 is configured to receive a supervisory signal from the network node containing optical transceiver 300, convert the supervisory signal to supervisory signal 210 and transmit supervisory signal 210 to input port 321 of electrical-to-optical assembly 320. Similarly, supervisory channel module 330 is also configured to receive supervisory signal 210 from optical-to-electrical assembly 310, convert supervisory signal 210 to an appropriate format, and transmit the reformatted supervisory signal to the network node containing optical transceiver 300. Supervisory channel module 330 includes a bi-directional data line 331, a field-programmable gate array (FPGA 332), EEPROM 333 for programming FPGA 332, a receiving UART 334, and a transmitting UART 335. Bi-directional data line 331 is a standard computer bus that links supervisory channel module 330 to the network node containing optical transceiver 300. One protocol commonly used in the art for interfacing a supervisory channel with an optical transceiver is I²C. FPGA 332 is configured to convert supervisory signal 210 received via receiving UART 334 to an I²C or other protocol to interface with the network node. Similarly, FPGA 332 is configured to convert a supervisory signal received from the network node to supervisory signal 210 for transmission to electrical-to-optical assembly 320 via transmitting UART 335.

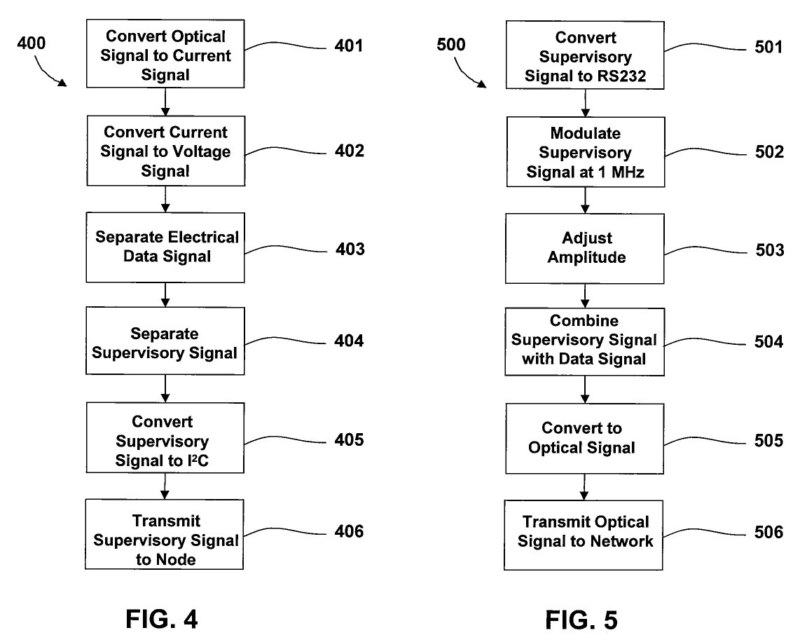

FIG. 4 is a flow chart summarizing an operating sequence 400 for optical transceiver 300, according to an embodiment of the invention. Operating sequence 400 describes the operation of optical transceiver 300 included in a network node when receiving a modulated data signal 240 from an adjacent network node.

In step 401, ROSA 311 receives modulated data signal 240 and converts the signal to modulated current signal 317.

In step 402, trans-impedance amplifier 312 coverts modulated current signal 317 to modulated voltage signal 318.

In step 403, limit amplifier 313 extracts data signal 230 from modulated voltage signal 318, transmitting data signal 230 as required to the network node.

In step 404, bandpass filter 314 and operational amplifier 315 separate supervisory signal 210 from modulated voltage signal 318 and transmit supervisory signal 210 to supervisory channel module 330.

In step 405, supervisory channel module 330 receives supervisory signal 210 and FPGA 332 converts the signal to an I²C protocol.

In step 406, supervisory channel module 330 transmits the I²C-formatted supervisory signal to the network node.

FIG. 5 is a flow chart summarizing an operating sequence 500 for optical transceiver 300, according to an embodiment of the invention. Operating sequence 500 describes the operation of optical transceiver 300 included in a network node when receiving a data signal 230 and supervisory signal 210 from the network node containing optical transceiver 300.

In step 501, supervisory channel module 330 receives an I²C-formatted supervisory signal and FPGA 332 converts the signal to an RS232 protocol signal, i.e., supervisory signal 210.

In step 502, electrical-to-optical assembly 320 receives supervisory signal 210 via electrical input port 321 and oscillator 322 modulates the signal at 1 MHz to produce modulated supervisory signal 220.

In step 503, operational amplifier 323 adjusts the amplitude of modulated supervisory signal 220 to a desired modulation depth relative to data signal 230.

In step 504, laser driver 324 superimposes modulated supervisory signal 220 and data signal 230 to produce laser control signal 326.

In step 505, TOSA 325 receives laser control signal 326 and converts laser control signal 326 into modulated data signal 240.

In step 506, modulated data signal 240 is transmitted to an adjacent network node.

While the foregoing is directed to embodiments of the present invention, other and further embodiments of the invention may be devised without departing from the basic scope thereof, and the scope thereof is determined by the claims that follow.

We claim:

1. An optical transceiver for a communications network, comprising:
an optical-to-electrical assembly configured to receive a first optical signal containing a first data signal and a first supervisory signal and separate the first optical signal into the first data signal and the first supervisory signal; and
an electrical-to-optical assembly configured to receive a second data signal and a second supervisory signal, and generate a second optical signal containing the second data signal and the second supervisory signal.

2. The optical transceiver of claim 1, wherein the first supervisory signal is superimposed onto the first data signal to form the first optical signal, and the second supervisory signal is superimposed onto the second data signal to form the second optical signal.

3. The optical transceiver of claim 2, wherein the frequency of the first data signal and the frequency of the second data signal are at least 1 GHz.

4. The optical transceiver of claim 3, wherein the frequency of the first supervisory signal and the frequency of the second supervisory signal are about 10 kHz.

5. The optical transceiver of claim 1, wherein the optical-to-electrical assembly includes a limit amplifier for extracting the first data signal and serially-connected bandpass filter and operational amplifier for extracting the first supervisory signal.

6. The optical transceiver of claim 5, wherein the optical-to-electrical assembly further includes serially-connected optical receiver unit and trans-impedance amplifier for receiving an optical signal and converting the optical signal to a voltage signal that is input to the limit amplifier and the bandpass filter.

7. The optical transceiver of claim 1, wherein the electrical-to-optical assembly includes a laser driver for superimposing a signal containing the second supervisory signal onto the second data signal.

8. The optical transceiver of claim 7, wherein the electrical-to-optical assembly further includes an oscillator for modulating the second supervisory signal to a higher frequency signal, and the higher frequency signal is superimposed onto the second data signal by the laser driver.

9. The optical transceiver of claim 8, wherein the frequency of the second supervisory signal is about 10 kHz, and the frequency of the higher frequency signal is about 1 MHz, and the frequency of the second data signal is about 1 GHz.

10. A small form-factor pluggable transceiver comprising the optical transceiver of claim 1.

11. A method of transmitting a supervisory signal between a first and second node of an optical communication network, comprising the steps of:
receiving a supervisory signal;
combining the supervisory signal with a data signal having a frequency of at least 1 GHz;
converting the combined signal to an optical signal; and
transmitting the optical signal containing the supervisory signal from the first node to the second node.

12. The method of claim 11, wherein the step of combining includes the step of modulating the supervisory signal to a higher frequency signal, wherein the higher frequency signal containing the supervisory signal is combined with the data signal.

13. The method of claim 12, wherein the frequency of the supervisory signal is about 10 kHz, and the frequency of the higher frequency signal is adjustable and is substantially separated from the frequency of the supervisory signal and the frequency of the data signal.

14. The method of claim 13, wherein the frequency of the higher frequency signal is about 1 MHz.

15. The method of claim 11, wherein the step of combining includes the step of superimposing the supervisory signal onto the data signal.

16. A method of extracting a supervisory signal from a combined signal received from a node of an optical communication network, comprising the steps of:
receiving a combined signal having the supervisory signal and a data signal having a frequency of at least 1 GHz;
extracting the data signal; and
extracting the supervisory signal.

17. The method of claim 16, wherein the step of extracting the supervisory signal includes filtering low and high frequency components of the combined signal, wherein the supervisory signal is extracted from the filtered signal.

18. The method of claim 17, wherein the supervisory signal is extracted from the filtered signal using an operational amplifier.

19. The method of claim 17, wherein the frequency of the supervisory signal is about 10 kHz.

20. The method of claim 19, wherein the frequency of the filtered signal is about 1 MHz.
